(19) United States
(12) Patent Application Publication
(10) Pub. No.: US 2017/0185999 A1
(43) Pub. Date: Jun. 29, 2017

(54) Secure Payment System

(71) Applicant: MASTERCARD INTERNATIONAL INCORPORATED, Purchase, NY (US)

(72) Inventor: Hasan AL-AALI, Doha (QA)

(21) Appl. No.: 15/388,307

(22) Filed: Dec. 22, 2016

(30) Foreign Application Priority Data
Dec. 23, 2015 (EP) 15202619.1

(51) Int. Cl. G06Q 20/38; H04L 12/46; H04L 29/12; G06Q 20/30

(52) U.S. Cl. CPC G06Q 20/382; G06Q 20/305; H04L 12/4633; H04L 61/2592; G06Q 2220/00

(57) ABSTRACT

A method for transmitting payment transaction data between a merchant platform and a vendor platform across a public network, the method comprising: creating a tunnel across the public network between the merchant platform and the vendor platform using a tunnelling protocol; extending encryption functionality from the vendor platform to the merchant platform through the tunnel; encrypting the transaction data at the merchant platform; and transmitting encrypted transaction data to the vendor platform across the public network through the tunnel.

### CROSS-REFERENCE TO RELATED APPLICATION

This application claims the benefit of and priority to European Patent Application No. 15202619.1, filed Dec. 23, 2015. The entire disclosure of the above application is incorporated herein by reference.

### FIELD

The present disclosure relates to a secure payment system for card transactions, and to a method of enabling secure card transactions. In particular, but not exclusively, the disclosure relates to a secure payment system and method for enabling merchants to verify card transactions.

### BACKGROUND

This section provides background information related to the present disclosure which is not necessarily prior art.

To enable a merchant to accept a card payment from a payment card, such as a credit or debit card, sensitive transaction data must be transmitted to a card issuing bank that has issued the payment card in order to authenticate and complete the transaction. Such transaction data may include, for example, a card number, a transaction amount and a merchant identifier. This data must be protected from malicious third parties who may attempt to intercept it during transmission for fraudulent purposes, and so it is important that the data is sent to the card issuer through a secure channel.

FIG. 1 shows an architecture for a known secure payment system 10 that is used for this purpose. The architecture is divided into a merchant platform 12 and a vendor platform 14, each platform representing, respectively, the physical hardware hosted and operated by each party. The merchant platform 12 and the vendor platform 14 are connected through a public switched telephone network (PSTN) 16.

The vendor platform 14 is hosted by a vendor that is capable of authenticating card transaction data. In this example, the vendor is the card issuing bank, but in alternative arrangements the vendor may be a payment network, such as the Applicant.

The merchant may be, for example, a high-street shop where a customer makes payment by inserting a payment card into a card reader. Card data is extracted automatically by the card reader and compiled with other transaction data, such as a merchant identifier, prior to transmission of the data to the card issuing bank. Alternatively, the merchant may be an online merchant, in which case a customer enters card details manually through a user interface.

The system 10 shown in FIG. 1 includes two terminals 18 in the merchant platform 12, although in practice there may be many more than two. Each terminal 18 may be a physical point of sale, such as the above mentioned card reader, or alternatively the terminals 18 may be servers configured to process card data for e-commerce transactions. In either case, the terminals 18 belong to a common merchant and are connected to a common first router 20 to define a merchant local network 22.

Transaction data is gathered by each terminal 18 and transmitted to the card issuing bank through the first router 20. Incoming and outgoing data from the first router 20 is processed by a first firewall device 24 to protect the merchant local network 22 from malicious third party attacks.

The first firewall device 24 includes network address translation (NAT) functionality which allows it to assume an IP address within an address space defined by the vendor platform 14, effectively hiding the components of the merchant local network 22 from the PSTN 16. This protects the status of the merchant local network 22 as a private network, improving security. Moreover, presenting the first firewall device 24 as residing within the address space of the vendor facilitates routing of data between the merchant platform 12 and the vendor platform 14.

After data passes through the first firewall device 24 it enters a vendor sub-network 26, the components of which are assigned IP addresses within the address space defined by the vendor platform 14. The data follows one of two data paths: a primary data path, and a secondary data path. The vendor sub-network 26 forms part of the merchant platform 12, but is managed by the card issuing bank and contains proprietary hardware that is configured to process and encrypt transaction data before it enters the PSTN 16. In this way, the vendor sub-network 26 creates a secure channel between the merchant platform 12 and the card issuing bank.

Specifically, each data path has a respective proprietary server 28, 30 that is arranged to encrypt the transaction data so that if the transaction data is intercepted by a malicious third party during transmission across the PSTN 16, that party will not be able to access the sensitive information contained within the encrypted transaction data.

The primary and secondary proprietary servers 28, 30 are both connected to a second router 32 which communicates with the PSTN 16 through a second firewall device 34. The primary and secondary data paths also include, respectively, a digital service unit 36 and a network terminal 38, each disposed between the second firewall device 34 and the PSTN 16.

The primary and secondary data paths carry encrypted transaction data across the PSTN 16 to a remote vendor server 40 hosted by the card issuing bank on the vendor platform 14. The vendor server 40 is configured to decrypt, process and verify the transaction data. If the transaction data is verified, the vendor server 40 then returns an authentication code to the terminal 18 of the merchant local network 22 from which the transaction data originated in order to complete the transaction. The authentication code is transmitted along the data path on which the transaction data arrived.

The primary and secondary data paths connect to the vendor platform 14 across the PSTN 16 in fundamentally different ways. This means that a fault affecting one of the data paths is unlikely to affect the other, therefore maximising the probability that one of the data paths will be operational at all times.

In the primary data path, a point-to-point network connection is established between the merchant platform 12 and the vendor platform 14. This connection is managed by the digital service unit 36, which acts as a gateway to the PSTN 16 for the primary data path. As the skilled reader will appreciate, a point-to-point connection is inherently secure, and so the primary data path is the preferred transmission route. Nevertheless, to enhance security, the primary proprietary server 28 associated with the primary data path uses a unique proprietary algorithm to encrypt data before transmitting it across the PSTN 16 through the point-to-point connection.

The secondary data path is provided as a backup option to ensure that the merchant is able to continue using card payment services in the event that the point-to-point connection used for the primary data path is not functioning correctly. For this reason, the secondary data path communicates with the vendor platform 14 using an ISDN-based virtual private network (VPN) that establishes a virtual point-to-point connection under the control of the network terminal 38, which acts as a gateway to the PSTN 16 for the secondary data path.

A typical implementation uses Internet Protocol security (IPsec) to establish the VPN, IPsec being a suite of open-standard security protocols that will be familiar to the skilled person. Within this suite are protocols for establishing mutual authentication between components of each platform at the start and end of each communications session, together with protocols enabling negotiation of cryptographic keys for the encryption of data transmitted through the VPN. This allows data to be transferred securely across the PSTN 16; although it is noted that there is a strong bias away from non-proprietary security measures in the field of payment processing systems, and so the secondary data path is only ever used as a backup.

The vendor server 40 uses multi-protocol-label-switching (MPLS) to handle incoming transaction data from the primary or secondary data paths. As MPLS is protocol independent, this arrangement enables the vendor platform 14 to use a single process to handle data from either the primary or the secondary data path, which as noted above transmits data using different protocols.

Systems such as that described above have developed historically in a context of a desire for ensuring high data integrity across a relatively insecure public network. In order to achieve the desired level of security, it is assumed that proprietary systems are required. However, it will be clear from the above description that the use of proprietary systems necessitated by this approach places a high burden on the merchant in terms of the physical hardware that it must obtain and manage, which is both expensive and time-consuming.

It is against this background that the present disclosure has been devised.

### SUMMARY

This section provides a general summary of the disclosure, and is not a comprehensive disclosure of its full scope or all of its features. Aspects and embodiments of the disclosure are also set out in the accompanying claims.

According to a first aspect of the disclosure there is provided a method for transmitting payment transaction data between a merchant platform and a vendor platform across a public network, the method comprising: creating a tunnel across the public network between the merchant platform and the vendor platform using a tunnelling protocol; extending an encryption functionality or process from the vendor platform to the merchant platform through the tunnel; encrypting the transaction data at the merchant platform; and transmitting encrypted transaction data to the vendor platform across the public network through the tunnel.

By creating a tunnel between the merchant and vendor platforms and providing an encryption functionality from the vendor platform to the merchant platform, beneficially there is no requirement for the merchant platform to include the necessary hardware or software for providing encryption functionality. This reduces the burden on a merchant hosting the merchant platform to acquire, configure and maintain such facilities, in turn avoiding the associated cost in terms of both time and financial expense.

The method may comprise extending authentication functionality or process from the vendor platform to the merchant platform, and authenticating data received at the merchant platform from the vendor platform. This further minimises the requirements for functionality that the merchant platform must provide.

Extending an encryption functionality or process from the vendor platform to the merchant platform through the tunnel may comprise the vendor platform running an encryption algorithm remotely on a device located on the merchant platform.

Extending an authentication functionality or process from the vendor platform to the merchant platform may comprise the vendor platform running an authentication algorithm on a device located on the merchant platform.

The method may comprise creating a virtual point-to-point connection between the merchant platform and the vendor platform using the tunnel, therefore making use of a readily available and secure method of connecting the platforms.

In some embodiments, the method comprises defining a respective security gateway on each platform, each gateway representing an endpoint of the tunnel. The gateway at the merchant platform may be, for example, a firewall device.

Advantageously, the method optionally comprises exchanging data between the merchant platform and the vendor platform as packets. In such embodiments, the method may comprise encapsulating each data packet prior to entry to the tunnel.

The tunnelling protocol may be internet-protocol based. For example, the tunnelling protocol may be IPsec protocol, in which case IPsec protocol may also be used to provide encryption. This is a convenient implementation that negates the need to provide proprietary algorithms for securing communications between the platforms, whilst still providing the necessary level of security for sensitive data transmitted through the tunnel.

The concept also extends to a processor configured to perform the method of the above aspect, and to a non-transitory computer-readable medium comprising computer code which, when executed, causes a processor to perform the method of the above aspect.

Another aspect of the disclosure provides a vendor platform configured to exchange payment transaction data with a merchant platform across a public network, the vendor platform comprising encryption means, such as an encryption module and a tunnelling module, the tunnelling module being configured to: create a tunnel across the public network from the vendor platform to the merchant platform using a tunnelling protocol; extend encryption functionality of the encryption means from the vendor platform to the merchant platform through the tunnel; encrypt the transaction data at the merchant platform; and transmit encrypted transaction data to the vendor platform across the public network through the tunnel.

It will be appreciated that exemplary and/or optional features of the first aspect of the disclosure may be incorporated alone or in appropriate combination in other aspects of the disclosure also.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an architecture for a known secure payment system and has already been described. In order that the disclosure may be more readily understood, exemplary non-limiting embodiments thereof will now be described, by way of example only, with reference to FIG. 2, which is a schematic illustration of an architecture for a secure payment system according to an embodiment of the disclosure.

Corresponding reference numerals generally indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

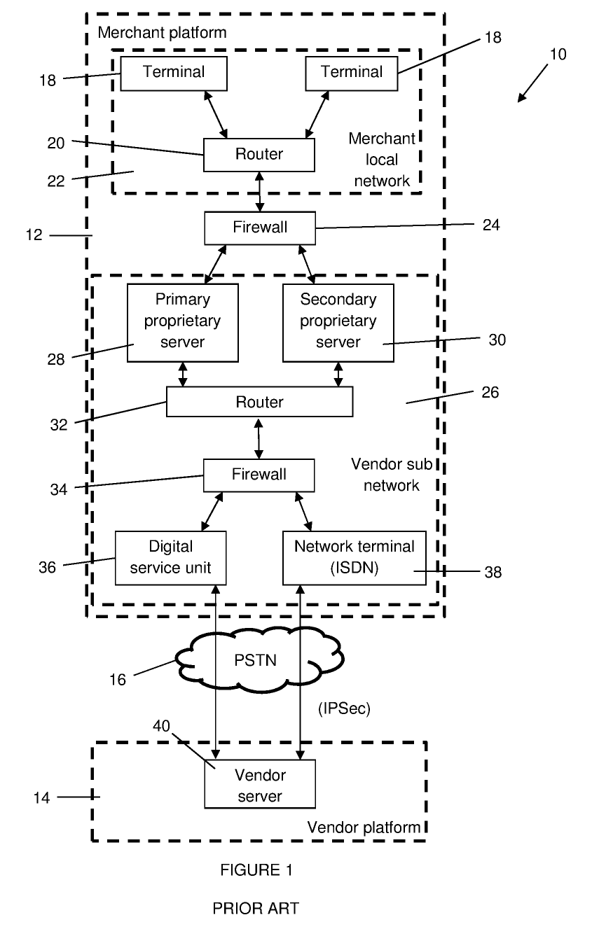

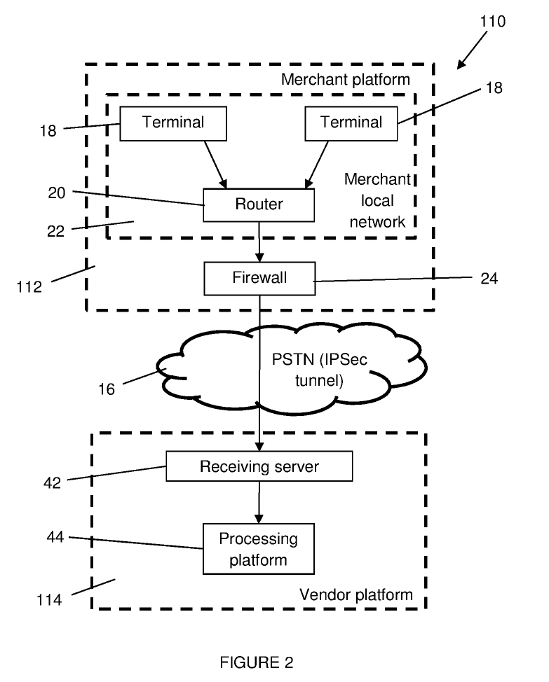

FIG. 2 shows an architecture for a secure payment system 110 according to an embodiment of the disclosure. As with the conventional system 10 shown in FIG. 1, the architecture is divided into a merchant platform 112 and a vendor platform 114 which communicate via a PSTN 16, each platform representing, respectively, the physical hardware hosted and operated by each party.

As in the known arrangement of FIG. 1, the vendor is a party which is capable of authenticating transaction data, such as a card issuing bank or a payment network, such as the Applicant. The merchant may be a shop where a customer makes payment using a physical payment card, or an online merchant, in which case a customer enters card details manually through a user interface. In either case, card data is obtained from a payment card and compiled with other transaction data, such as a merchant identifier, prior to transmission of the data to the vendor.

It will be immediately apparent that the merchant platform, shown in FIG. 2, contains significantly fewer components than the corresponding platform of the known system 10 of FIG. 1. Specifically, in contrast with the known system 10, the system 110 of FIG. 2 does not include a vendor sub-network, and so does not contain proprietary servers, a second router, a second firewall device, a digital service unit or a network terminal. Moreover, in FIG. 2, there is only a single data path in the place of the primary and secondary data paths that are used in the known arrangement.

The reasons for this reduction in system components are outlined below, but it is noted at this point that the omission of the vendor sub-network from the hardware arrangement represents a significant benefit to the merchant which no longer has to acquire, configure and maintain proprietary hardware, thereby avoiding the associated configuration time and financial outlay.

Considering the configuration shown in FIG. 2 in more detail, the merchant platform 112 includes a merchant local network 22 which is similar to that of the known arrangement described above with reference to FIG. 1. Accordingly, the merchant local network 22 of FIG. 2 includes a pair of terminals 18 connected to a common router 20. Many further terminals 18 may be included in the merchant local network 22 in practice. The router 20 is in turn connected to a firewall device 24 which enables the merchant local network 22 to communicate with the PSTN 16.

As in the known arrangement, in the FIG. 2 embodiment the firewall device 24 provides NAT functionality and so hides the merchant local network 22 from the PSTN 16, while presenting an IP address within an address space defined by the vendor platform 114 and so facilitating routing of data between the merchant and vendor platforms 112, 114. The firewall device 24 is also arranged to act as an end terminal for a VPN that is established between the merchant platform 112 and the vendor platform 114, as shall become clear in the description that follows.

As FIG. 2 shows, the vendor platform 114 includes a receiving server 42 that is arranged to receive incoming transaction data from the PSTN 16, and a processing platform 44 that is arranged to analyse the data to extract the required transaction details, and to verify the transaction.

In a similar arrangement to the secondary path of the known system 10 of FIG. 1, in this embodiment transaction data is transmitted from the merchant platform 112 to the receiving server 42 of the vendor platform 114 through a VPN established across the PSTN 16.

Unlike the known arrangement, in this embodiment the merchant platform 112 does not include hardware components that can provide the required functionality for establishing a VPN session. Instead, tunnelling protocols are used by the vendor platform 114 to provide this functionality remotely; tunnelling protocols create a tunnel between a pair of networks to enable the functionality of one network to be extended to the other.

In this case, the vendor platform 114 includes the functionality required to establish a VPN, including encryption and authentication functions. Specifically, these functions are provided by the receiving server 42, which therefore acts as a tunnelling module comprising encryption means in the form of an encryption module or device and authentication means in the form of an authentication module or device. So, the tunnel is used to extend these functions from the vendor platform 114 to the merchant platform 112 and thereby enable creation of a VPN between the two.

In simplified terms, the tunnel allows the vendor platform 114 to run encryption and authentication algorithms remotely on a suitable device located on the merchant platform 112. In this embodiment, the firewall device 24 is used in this regard. As tunnelling protocols are standardised and operate within defined programming structures, they can exploit the built-in functionality of conventional devices, such as the firewall device 24, which do not require any modification to enable this.

By providing encryption and authentication at each end of the tunnel, the tunnel establishes a secure channel between the merchant platform 112 and the vendor platform 114, thereby protecting the integrity of payment transaction data and payment authentication codes exchanged between the two platforms 112, 114. Incoming encrypted data at the vendor platform 114 is decrypted by the receiving server 42 and passed to the processing platform 44 for authentication.

In this way, the architecture according to the embodiment shown in FIG. 2 is capable of providing a similar arrangement to the secondary data path of the conventional arrangement of FIG. 1, but without having to provide dedicated components at the merchant platform 112.

Endpoints of the tunnel are defined by a respective security gateway on each platform, i.e. a point at which data enters and exits each platform from the tunnel. The firewall device 24 is used as a gateway on the merchant platform 112, and the receiving server 42 defines the gateway on the vendor platform 114.

Various tunnelling protocols are available that could be used in this application. In this embodiment, IPsec tunnelling protocol is used, as the Applicant has found that this provides the required level of security for a payment processing system. With IPsec tunnelling protocol, data is transmitted in IP data packets, each packet comprising a packet header identifying the nature of the packet, and a payload containing the data. IPsec protocol enables the IP data packets to be exchanged between platforms securely using encryption and authentication, and can be operated in a tunnelling mode in which the data packets are encapsulated by adding a new packet header, thereby protecting the contents of the original packet when transmitted across a public network.

It is noted that due to the omission of proprietary hardware at the merchant platform 112, the transaction data does not undergo any initial encryption according to proprietary algorithms as in the conventional arrangement. In this embodiment, the IPsec protocol is entirely relied upon to provide the required encryption to ensure security of the transaction data and so create a secure channel between the merchant platform 112 and the vendor platform 114. This sits in stark contrast with conventional thinking in the art which, as already noted, takes a strong bias towards the use of proprietary security systems.

Although in the above described embodiment a VPN is established between the merchant platform 112 and the vendor platform 114. In a simpler arrangement, this may not be necessary and data integrity can be ensured using basic encryption and authentication. As before, encryption and authentication functionality is extended to the merchant platform 112 via the tunnel, as the merchant platform 112 does not have the physical hardware required to execute these functions.

It will be appreciated by a person skilled in the art that the details of the disclosure could be modified to take many alternative forms to that described herein, without departing from the scope of the appended claims.

With that said, it should be appreciated that one or more aspects of the present disclosure transform a general-purpose computing device into a special-purpose computing device when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for transmitting payment transaction data between a merchant platform and a vendor platform across a public network, the method comprising:
creating, by a processor, a tunnel across the public network between the merchant platform and the vendor platform using a tunnelling protocol;
extending, by the processor, an encryption functionality from the vendor platform to the merchant platform through the tunnel;
encrypting, by the processor, the transaction data at the merchant platform; and
transmitting, by the processor, encrypted transaction data to the vendor platform across the public network through the tunnel.

2. The method of claim 1, further comprising extending authentication functionality from the vendor platform to the merchant platform, and authenticating data received at the merchant platform from the vendor platform.

3. The method of claim 1, further comprising creating a virtual point-to-point connection between the merchant platform and the vendor platform using the tunnel.

4. The method of claim 1, further comprising defining a respective security gateway on each platform, each gateway representing an endpoint of the tunnel.

5. The method of claim 1, comprising exchanging data between the merchant platform and the vendor platform as data packets.

6. The method of claim 5, comprising encapsulating each data packet prior to entry to the tunnel.

7. The method of claim 1, wherein the tunnelling protocol is internet-protocol based.

8. The method of claim 7, wherein the tunnelling protocol is IPsec protocol.

9. The method of claim-8 claim 1, wherein encryption is provided by IPsec protocol.

10. (canceled)

11. (canceled)

12. A vendor platform configured to exchange payment transaction data with a merchant platform across a public network, the vendor platform comprising an encryption module and a tunnelling module, the tunnelling module being configured to:
create a tunnel across the public network from the vendor platform to the merchant platform using a tunnelling protocol;
extend an encryption functionality of the encryption means module from the vendor platform to the merchant platform through the tunnel;
encrypt the transaction data at the merchant platform; and
transmit encrypted transaction data to the vendor platform across the public network through the tunnel.

13. The method of claim 1, wherein extending an encryption functionality from the vendor platform to the merchant platform through the tunnel comprises the vendor platform running an encryption algorithm remotely on a device located on the merchant platform.

14. The method of claim 2, wherein extending an authentication functionality from the vendor platform to the merchant platform comprises the vendor platform running an authentication algorithm on a device located on the merchant platform.

15. The method of claim 2, further comprising creating a virtual point-to-point connection between the merchant platform and the vendor platform using the tunnel.

16. The method of claim 3, wherein the tunneling protocol is internet-protocol based.

17. A vendor platform configured to exchange payment transaction data with a merchant platform across a public network, the vendor platform comprising an encryption module and a tunnelling module, the tunnelling module being configured to:
create a tunnel across the public network from the vendor platform to the merchant platform using a tunnelling protocol;
run an encryption algorithm remotely on a device located on the merchant platform to extend encryption functionality from the vendor platform to the merchant platform through the tunnel;
encrypt the transaction data at the merchant platform;
transmit encrypted transaction data to the vendor platform across the public network through the tunnel;
run an authentication algorithm remotely on a device located on the merchant platform to extend authentication functionality from the vendor platform to the merchant platform; and
authenticate data received at the merchant platform from the vendor platform.

18. The vendor platform of claim 17, wherein the tunnelling module is further configured to exchange data between the merchant platform and the vendor platform as data packets.

19. The vendor platform of claim 18, wherein the tunnelling module is further configured to encapsulate each data packet prior to entry to the tunnel.

20. The vendor platform of claim 17, wherein the tunnelling protocol is internet-protocol based.
